(19) United States
(12) Patent Application Publication
(10) Pub. No.: US 2004/0164689 A1
(43) Pub. Date: Aug. 26, 2004

(54) Control system for lighting devices

(76) Inventor: Richard Knight, Bournemouth (GB)

Correspondence Address: HULSEY, GRETHER, FORTKORT & WEBSTER, LLP, 8911 N. CAPITAL OF TEXAS HWY., SUITE 3200, AUSTIN, TX, 78759, US

(21) Appl. No.: 10/786,257

(22) Filed: Feb. 25, 2004

(30) Foreign Application Priority Data
Feb. 26, 2003 (GB) GB2379100

(51) Int. Cl. H05B 37/00

(52) U.S. Cl. 315/294; 315/292; 315/324

(57) ABSTRACT

A control system for automated lights comprises a controller (1) having an output signal comprising a plurality of channels (13, 14, 15) transmitted repeatedly in sequence and at least one addressable receiver (3, 4, 5) connected to the controller and arranged to receive at least some of the channels for operating an automated light (6, 7, 8). The controller is arranged to encode instructions for the or each receiver and send each encoded instruction using a predetermined number of consecutive channels of the output signal, the predetermined number being at least two, and the receiver is arranged to combine information received from the predetermined number of consecutive channels to form one encoded instruction, decode the encoded instruction, and operate the automated light on the basis of the decoded instruction.

This application claims the priority of United Kingdom patent application number GB2379100 dated 26 Feb. 2003 filed on behalf of the inventor Richard Knight.

The present invention relates generally to the field of control systems for lighting devices, and in particular to electronically addressable lighting devices.

Theatre lighting systems used in stage productions are often elaborate and include many different lighting devices and effects devices in order to produce desired lighting effects. In recent years, many different aspects of lighting systems have been computerised so as to improve the control of the various devices. While many different control systems are available for this purpose, one protocol which is generally accepted for use in theatre lighting in particular is the DMX-512 protocol. DMX-512 protocol refers to a protocol standard as defined by the United States Institute for Theater Technology, Inc. (USITT).

A controller, or console, using the DMX-512 protocol sends signals down control lines to lighting units. Most lighting consoles send along more than one control line, with the largest currently using 6 lines. The console sends a series of data packets down the control line, each data packet comprising up to 512 individual channels sent in series. This signal can be transmitted to any number of connected lighting system devices or receivers. Each receiver contains a manually set address circuit, enabling the receiver to pick out a channel from each data packet to take instructions from the console.

Each of the channels in a packet consists of a single 8-bit byte, and may therefore have one of 256 values (usually numbered from 0 to 255). Traditionally, lights have been controlled from consoles using linear analogue controllers, so the 256 values may be used to imitate this. For example, if the console is used to control the intensity of a light, the settings of the channel would be used in a linear form, with 0 being zero intensity, 128 being half and 255 being full. A similar system may be used with a separate channel for example to control beam size, running from 0 (small) to 255 (large). A sophisticated automated light can require up to 22 channels to control most of its attributes, such as colour, beam size, intensity, pan, tilt, etc. All of these attributes use a linear or incremental application of the 256 steps.

For certain applications, such as movement, the 256 steps provided by a single channel do not provide sufficiently fine control. For example, for a light which can be moved through a 360° arc, a change from e.g. 121 to 122 in the channel's output will cause the light to move through more than 1°. This problem can be overcome by the use of two channels, “coarse” and “fine”. The console sends a “coarse” instruction using one channel, and once the light is in the correct general position, it sends a “fine” instruction using a different channel. This is referred to as “16 Bit” in automated lighting. The light responds to this second instruction by moving a far smaller amount. It will be appreciated that, if 16 Bit is correctly implemented using two separate control channels, this allows the light to be set to any one of 65,536 (256×256) positions, and in the case of the 360° light mentioned above, this allows a precision of ˜0.005°.

Another way in which DMX channels are currently used is as a switch. For example, the values 0-56 of a channel may be allocated to switch on a particular attribute “A” of a light; the values 57-128 allocated to switch on attribute “B” (and to switch off attribute “A”); 129-184 allocated to switch on attribute “C”; and 185-255 allocated to switch on attribute “D”. This system evolved to imitate the action of an analogue “fader” on a console, the large attribute widths being necessary for fader movement which is by its nature approximate. The system is linear, in that if the light has attribute “A” switched on and a user wishes to access attribute “D”, he will have to pass through “B” and “C”.

The DMX-512 protocol has generally been used exclusively in a linear fashion for historical reasons to do with replacing linear analogue faders. If an analogue fader supplying 0-10 V dc was used, it was intrinsic that voltage level 10 could only be reached by passing through voltage level 9. It is recognised in the present invention that the step number of a DMX channel has no intrinsic relationship to any other step number, so the channels do need not be used in a linear fashion. The console can send an output on one DMX channel of 38 followed immediately in the next data packet by an output on the same channel of 173, there being no need to pass through the values in between.

A particular problem associated with the use of DMX-512 channels is that if a single console controls many lights it is possible to run out of channels, since each attribute of each light requires its own channel.

In accordance with a first aspect of the present invention there is provided a control system for automated lights, comprising: a controller having an output signal comprising a plurality of channels transmitted repeatedly in sequence; at least one addressable receiver for operating an automated light, the receiver being connected to the controller and arranged to receive at least some of the channels; wherein the controller is arranged to encode instructions for the or each receiver and send each encoded instruction using a predetermined number of consecutive channels of the output signal, the predetermined number being at least two; and wherein the receiver is arranged to combine information received from the predetermined number of consecutive channels to form one encoded instruction, decode the encoded instruction, and operate the automated light on the basis of the decoded instruction.

In a preferred embodiment the receiver comprises a memory, the encoded instruction refers to a location in said memory, and the receiver is arranged to decode the instruction by accessing the referred memory point.

The encoded instruction may correspond to a database entry, the receiver being arranged to decode the encoded instruction by accessing a database.

Preferably one channel of the consecutive channels contains information regarding which attribute of the automated light is to be controlled, and the other channel or channels contains information regarding how that attribute is to be set.

The predetermined number of consecutive channels is preferably three.

In a preferred embodiment each channel can be set to any one of 256 values, and the controller transmits data in accordance with the DMX-512 protocol.

In accordance with a second aspect of the present invention there is provided apparatus for controlling an automated light, comprising: a receiver arranged to receive an output signal comprising a plurality of channels transmitted repeatedly in sequence from a controller, and operate the automated light on the basis of instructions received in the output signal; wherein the receiver is arranged to receive at least two consecutive channels for each instruction, and combine the information received from all of the at least two channels to determine each instruction.

In accordance with a third aspect of the present invention there is provided a method for controlling an automated light, comprising: encoding an instruction at a controller; sending a data packet comprising a series of channels from the controller to a receiver, the encoded instruction being sent as a predetermined number of two or more channels of the data packet; receiving the data packet at the receiver; combining the information contained in the predetermined number of consecutive channels at the receiver so as to determine the encoded instruction; decoding the instruction; and controlling the light in accordance with the instruction.

Preferably the receiver comprises a memory, the encoded instruction refers to a location in said memory, and the receiver decodes the instruction by accessing the referred memory point.

The instruction is preferably encoded so that it comprises three channels of a data packet.

The data packet is preferably sent in accordance with the DMX-512 protocol.

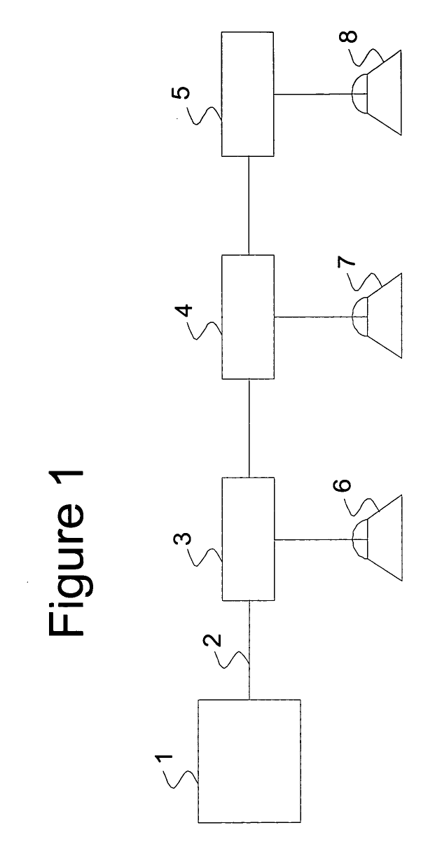

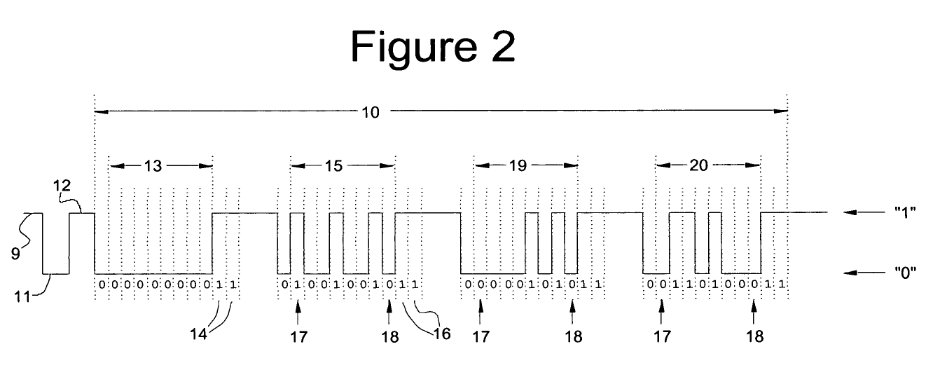

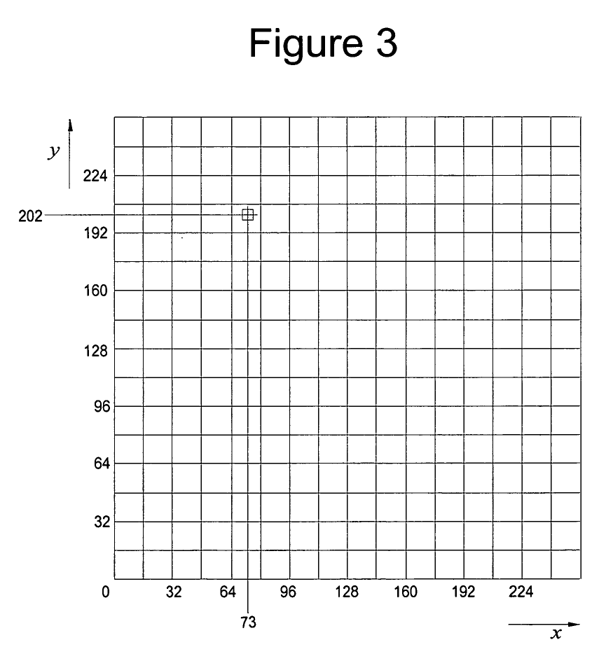

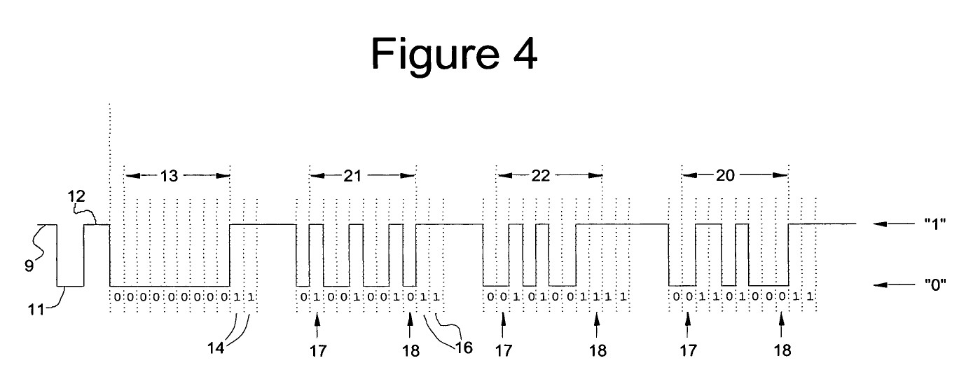

Some preferred embodiments of the invention will now be described by way of example only and with reference to the accompanying drawings, in which: FIG. 1 shows schematically a typical arrangement of automated lights; FIG. 2 shows part of a typical DMX-512 data packet; FIG. 3 shows a virtual square enabling access to memory points in accordance with the invention; and FIG. 4 shows a DMX-512 data packet in accordance with the invention.

FIG. 1 is a schematic diagram showing a typical arrangement of automated lights. A central control console 1 is connected via a control line 2 to three receivers 3, 4, 5. Each receiver 3, 4, 5 controls the operation of a light 6, 7, 8 in response to signals from the console 1.

The console transmits an output signal at a rate of typically 250 kbps. According to the DMX-512 protocol, the output signal consists of data packets, each comprising a series of channels as shown in FIG. 2. In its idle state, the output signal is held at a mark level 9, corresponding to a digital “1”. Before a data packet 10 is sent, a break signal 11 is sent by dropping the line to its low condition, or digital “0”, for at least 88 μs, which corresponds to two frame times. Following the break signal, a mark after break 12 is sent. This is a general synchronisation pulse for the start of the data portion of the DMX packet, and warns the receivers that the next transition from high to low will be the start of data.

The first portion of the data packet is a low start bit (set to “0”) followed by a byte of eight “0”s 13 immediately followed by two high stop bits 14. This is known as a Null Start Code and indicates to the receiver that valid channel information is to follow. Other start codes can be used, but receivers are arranged so that they will not act on information contained in channels unless a Null Start Code has been received.

The first channel 15 is sent after the start code 13. The channel consists of a low start bit followed by an eight-bit byte, immediately followed by two high stop bits 16 closing the byte. The least significant bit 17 is sent first after the start bit and the most significant bit 18 last before the stop bits 16. It is clear from the foregoing that the channel can take any value from 0 to 255.

Following the first channel, a plurality of other channels 19, 20 up to a maximum of 512 are then sent. This method of sending information in channels allows instructions to be sent down a single line to many receivers, as shown in FIG. 1. Each receiver is configured to receive information from one or more channels. For example, the first receiver 3 may be configured to receive the information in the first channel 15, the second receiver 4 to receive the information in the second channel 19, and the third receiver 5 to receive the information in the third channel 20.

In practice, using the prior art system, each receiver is configured to receive typically at least 16 and possibly up to 22 channels, depending on the complexity and number of attributes of the light. These channels can then be used to control different properties of each light. For example, rather than the first receiver 3 being configured to receive only channel one 15, it could be configure to receive the first sixteen channels, and take instructions for intensity from channel one 15, brightness from channel two 19 and tilt from channel three 20. It is also possible to use two channels to give a “coarse” and “fine” instruction to a receiver, as discussed above in the introduction.

Using the prior art system, if there are many lights controlled from a single console, where each attribute of each light requires its own channel, it is possible to run out of channels. To overcome this problem, in one embodiment of the invention, instructions are encoded so that an individual instruction is sent using two or more channels.

This is achieved without any need to change the protocol for transmitting data. The first receiver 3 is configured to receive information from both the first and second channels 13, 15 of each data packet. The receiver maintains a database in its memory of instructions associated with the values received with the channels. This can be thought of as comprising a virtual square, as shown in FIG. 3. The location in the receiver's memory is identified in the square, with the value received in channel one corresponding to the x-axis, and the value received in channel two corresponding to the y-axis.

FIG. 4 shows the beginning of a data packet containing channels which are to be used with this system. The first channel 21 is set to the value 73, which is transmitted as the byte 01001001, and the second channel 22 is set to the value 202, which is transmitted as the byte 11001010. The receiver 3 records both values, and looks up the point (73,202) in its memory database (see FIG. 3). That memory point contains an instruction which is acted on by the receiver to operate the light 6.

It will be appreciated that this allows far more efficient use of channels. For example, the first channel 21 could be used to specify which attribute of the light 6 is to be controlled, and the second channel 22 provides the value that attribute is to be set to. Thus if the light 6 has 22 attributes, each of which can be set to any of 256 values, this can be fully controlled using just two channels, as opposed to the 22 required in the prior art system. Another way to consider this is with the virtual square providing 256×256 (=65,536) memory points. The first channel 21 identifies a column on the square, with each column corresponding to a particular attribute of the light 6. The second channel 22 then identifies the position in the column, corresponding to the value that attribute is to take.

There is no requirement to change the start code of the data packet to warn receivers that this system is to be used. As far as the console is concerned, the data is sent in the same way as before, with a null start code 13 followed by a series of channels 21, 22, 20. The receiver itself is set up so that it only accepts two channels of the output signal, but these two channels are combined into one instruction and decoded to allow the receiver to access any one of 65,536 instructions.

It will be appreciated that there is no need to limit the application to the use of two channels. For example, three consecutive channels could be used, enabling a total of 256×256×256=16,777,216 different memory points to be addressable for a single instruction. This could be thought of as a virtual cube, with each of the three channels providing an x, y, or z co-ordinate. The first channel can be used to identify an attribute of the light 6 corresponding to the y-z plane of the cube, and the second and third channels used to set the value for that attribute, by identifying a point in that y-z plane.

Furthermore, three channels could be used, with the first identifying an attribute of the light, the second setting a “coarse” value for that attribute and the third setting a “fine” value for that attribute. The receiver would be set up to receive three channels of a data packet. If even more memory points are needed, four or more channels could be used.

It will be appreciated that variations from the above described embodiments will still fall within the scope of the invention. For example, the embodiments have been described with reference to the DMX-512 protocol but the system can be used with any data transfer protocol which operates using a serial sequence of channels. Such a protocol has been suggested which uses 1024 channels and may be called the DMX1024 protocol. Another example of such a protocol is the Synchronous Data Transmission Protocol, or SDX.

1. A control system for automated lights, comprising:
a controller having an output signal comprising a plurality of channels transmitted repeatedly in sequence;
at least one addressable receiver for operating an automated light, the receiver being connected to the controller and arranged to receive at least some of the channels;
wherein the controller is arranged to encode instructions for the or each receiver and send each encoded instruction using a predetermined number of consecutive channels of the output signal, the predetermined number being at least two;
and wherein the receiver is arranged to combine information received from the predetermined number of consecutive channels to form one encoded instruction, decode the encoded instruction, and operate the automated light on the basis of the decoded instruction.

2. A control system as claimed in claim 1, wherein:
the receiver comprises a memory;
the encoded instruction refers to a location in said memory;
and the receiver is arranged to decode the instruction by accessing the referred memory point.

3. A control system as claimed in claim 1, wherein the encoded instruction corresponds to an entry in a database and the receiver is arranged to decode the encoded instruction by accessing the database.

4. A control system as claimed in claim 1, wherein the controller is arranged to encode the instruction such that one channel of the consecutive channels contains information regarding which attribute of the automated light is to be controlled, and the other channel or channels contains information regarding how that attribute is to be set.

5. A control system as claimed in claim 1, wherein the predetermined number of consecutive channels is three.

6. A control system as claimed in claim 1, wherein each channel can be set to any one of 256 values.

7. A control system as claimed in claim 1, wherein the controller is arranged to transmit the output signal in accordance with the DMX-512 protocol.

8. A control system as claimed in claim 2, wherein the encoded instruction corresponds to an entry in a database and the receiver is arranged to decode the encoded instruction by accessing the database.

9. A control system as claimed in claim 2, wherein the controller is arranged to encode the instruction such that one channel of the consecutive channels contains information regarding which attribute of the automated light is to be controlled, and the other channel or channels contains information regarding how that attribute is to be set.

10. A control system as claimed in claim 2, wherein the predetermined number of consecutive channels is three.

11. A control system as claimed in claim 2, wherein each channel can be set to any one of 256 values.

12. A control system as claimed in claim 2, wherein the controller is arranged to transmit the output signal in accordance with the DMX-512 protocol.

13. A control system as claimed in claim 3, wherein the controller is arranged to encode the instruction such that one channel of the consecutive channels contains information regarding which attribute of the automated light is to be controlled, and the other channel or channels contains information regarding how that attribute is to be set.

14. A control system as claimed in claim 3, wherein the predetermined number of consecutive channels is three.

15. A control system as claimed in claim 3, wherein each channel can be set to any one of 256 values.

16. A control system as claimed in claim 3, wherein the controller is arranged to transmit the output signal in accordance with the DMX-512 protocol.

17. A control system as claimed in claim 4, wherein the predetermined number of consecutive channels is three.

18. A control system as claimed in claim 4, wherein each channel can be set to any one of 256 values.

19. A control system as claimed in claim 4, wherein the controller is arranged to transmit the output signal in accordance with the DMX-512 protocol.

20. A control system as claimed in claim 5, wherein each channel can be set to any one of 256 values.

21. A control system as claimed in claim 5, wherein the controller is arranged to transmit the output signal in accordance with the DMX-512 protocol.

22. A control system as claimed in claim 6, wherein the controller is arranged to transmit the output signal in accordance with the DMX-512 protocol.

23. Apparatus for controlling an automated light, comprising:
a receiver arranged to receive an output signal comprising a plurality of channels transmitted repeatedly in sequence from a controller and operate the automated light on the basis of instructions received in the output signal;
wherein the receiver is arranged to receive at least two consecutive channels for each instruction, and combine the information received from all of the at least two channels to determine each instruction.

24. A method for controlling an automated light, comprising:
encoding an instruction at a controller;
sending a data packet comprising a series of channels from the controller to a receiver, the encoded instruction being sent as a predetermined number of two or more channels of the data packet;
receiving the data packet at the receiver;
combining the information contained in the predetermined number of consecutive channels at the receiver so as to determine the encoded instruction;
decoding the instruction; and
controlling the light in accordance with the instruction.

25. A method as claimed in claim 9, wherein:
the receiver comprises a memory;
the encoded instruction refers to a location in said memory;
and the receiver decodes the instruction by accessing the referred memory point.

26. A method as claimed in claim 9, wherein the instruction is encoded so that it can be sent as three channels of a data packet.

27. A method as claimed in any claim 9, wherein the data packet is sent in accordance with the DMX-512 protocol.

28. A method as claimed in claim 10, wherein the instruction is encoded so that it can be sent as three channels of a data packet.

29. A method as claimed in any claim 10, wherein the data packet is sent in accordance with the DMX-512 protocol.

30. A method as claimed in any claim 11, wherein the data packet is sent in accordance with the DMX-512 protocol.
